(19) United States
(12) Patent Application Publication
(10) Pub. No.: US 2006/0289176 A1
(43) Pub. Date: Dec. 28, 2006

(54) Apparatus for fire control

(76) Inventors: Raymond Leonard Butler, New South Wales (AU); Richard John Barrington, New South Wales (AU)

Correspondence Address: KING & SCHICKLI, PLLC, 247 NORTH BROADWAY, LEXINGTON, KY, 40507, US

(21) Appl. No.: 10/550,441

(22) PCT Filed: Mar. 25, 2004
(86) PCT No.: PCT/AU04/00363

§ 371 Date: Jul. 10, 2006

(30) Foreign Application Priority Data
Mar. 25, 2003 (AU) 2003901364
Jan. 7, 2004 (AU) 2004900082

(51) Int. Cl. A62C 3/00

(52) U.S. Cl. 169/54

(57) ABSTRACT

According to one aspect of the present invention there is provided a fire fighting apparatus, including one or more sprinklers, the or each sprinkler in the use position being mounted in the region of a structure so that when fluid is forced under pressure through the or each sprinkler, a radiant heat barrier of fluid droplets is formed. According to another aspect of the present invention there is provided a sprinkler head suitable for use in forming a radiant heat barrier in the form of droplets of fire-fighting fluid in at least a single plane, the sprinkler head including at least one radial arm pivotally connected at its centre to a hub about which the or each radial arm pivots, the or each arm including one or more generally tangential extensions, the or each extension disposed at an outer end of, and in fluid communication with a respective radial arm, so that fire-fighting fluid may be sprayed from the sprinkler head to form the radiant heat barrier in at least the radial plane. According to yet another aspect of the present invention there is provided a fire fighting apparatus suitable for use with a sprinkler or sprinkler system, the sprinkler and sprinkler system including a water supply under pressure, the water delivered to one or more selected locations via water delivery pipes having an outlet at the selected location and at least one sprinkler head in fluid communication with the outlet, the fire fighting apparatus including: a fire retardant supply and a proportioning means in fluid communication with the fire retardant supply and water delivery pipes, wherein the proportioning means delivers the fire retardant in a selected and controlled concentration to the water supply in the water delivery pipes.

### FIELD OF THE INVENTION

The present invention relates generally to controlling the spread of fire by forcing a fluid through one or more sprinkler heads. Applications for the present invention include sprinklers in and around building exteriors, building grounds, building interiors, ships, aircraft and fire fighting vehicles.

### BACKGROUND TO THE INVENTION

Known systems for controlling the spread of fire by forcing fluid through sprinkler heads generally include a water supply under pressure that is carried through pipes to a sprinkler head at a selected location. A heat-activation system generally provides a one-shot switching device so that water is released through the sprinkler head to the selected location if local heat exceeds a selected threshold. These systems are found almost exclusively in multi-storey buildings. When activated, a great deal of water is sprayed from the sprinkler heads, causing much water wastage and a great deal of damage to files and other property.

In other applications such as houses in bushfire-prone areas, garden sprinklers and garden hoses are often placed on house rooves in order to damp and cool the roof and structure. Water from the sprinklers and hoses fills plugged gutters disposed around the lower perimeter of the roof. Water pools in and overflows the gutters to provide cooling to surrounding areas, leading to lower risk of combustion and other damage from radiant heat, flames and embers. Again, large amounts of water are required in order to deliver sufficient cooling to the house.

Some applications generally use a chemical additive in the form of a fire retardant. The chemical is added to water which is sprayed through hoses having nozzles, and/or dropped from aircraft ha-ving large suspended buckets and/or dropped from the bellies of specially-designed aircraft. Generally retardants are added to a reservoir, and the retardant spreads through the reservoir through natural convection/displacement. The only mechanical mixing occurs via the normal bumping occurring through transport to the fire site, leading to a potentially uneven or at least uncontrolled concentration of fire retardant.

Until recently, problems have arisen when using known retardants in sprinklers because, among other things such as increased corrosive qualities, they have a difficult viscosity so that a mixture of retardant and water causes foaming and thus ineffective fire control when forced through a sprinkler head. For these reasons, it is understood in the art that no suppressants may be used as additives in sprinkler systems. However, a new product has emerged as an additive, for use as a fire suppressant. This product has unexpected properties which have not been utilised except in large reservoirs. In addition, the new generation of retardant allows water to perform its cooling function without driving the moisture off as steam, allowing a reduction in the amount of water used to control the spread of fire.

In other known systems, radiant heat barriers have been constructed from, for example, 6-foot-tall steel sheeting. This sheeting is expensive to install, and these barriers can easily be destroyed by flame fronts.

Finally, the sprinklers which are in use in the known systems described above, provide limited and inefficient performance for fire-fighting because they have essentially been designed for use in agriculture or the like and not specifically designed for use in fire-fighting applications. Known systems use far more water than necessary to perform a fire control function.

The present invention seeks to ameliorate one or more of the abovementioned disadvantages.

### SUMMARY OF THE INVENTION

There are several distinct and separate aspects of the present invention which as a matter of convenience will hereinafter be described in combination. It is to be understood however that this is not to be taken as a limitation of the scope of the invention in any of its distinct aspects.

According to one aspect of the present invention there is provided a fire fighting apparatus, including one or more sprinklers, the or each sprinkler in the use position being mounted in the region of a structure so that when fluid is forced under pressure through the or each sprinkler, a radiant heat barrier of fluid droplets is formed.

In many applications, a wall of a building is of a larger area than may be satisfactorily protected by a single sprinkler head being supplied with a low to medium pressure mains water supply. Therefore, in preferred embodiments a single-dimensional or two-dimensional array of sprinklers are provided adjacent to a building wall, in order to provide an overlap of the barrier.

A mounting means may be provided, and may be in the form of a state, or similar device for mounting in the ground a distance from a building, or may be a bracket.

Preferably the sprinklers are mounted on the building wall, so that the barrier in use is provided between the sprinkler and the advancing fire, to protect the sprinkler and the wall.

Preferably a fire fighting apparatus as described above may be provided wherein the or each sprinkler is mounted to a wall of a building having eaves, the sprinkler mounted under the eaves so that at least one of the planes of fluid intersects with the plane of the eaves.

Preferably a fire fighting apparatus as described above may be provided wherein at least one of the planes of fluid intersects with the plane of a wall of the structure.

Preferably, a fire fighting apparatus as described above may be provided wherein a one-dimensional or two-dimensional array of sprinkler heads are provided adjacent to a building wall, each sprinkler spaced from adjacent sprinkler or sprinklers in order to provide an overlap of the heat-reducing barrier.

Preferably a fire fighting apparatus as described above may be provided wherein an additive is provided to the fire fighting fluid in the form of a fire suppressant.

The fire-fighting fluid may be suitable fire-fighting agents, and in one preferred form the fluid is water.

According to another aspect of the present invention there is provided a sprinkler head suitable for use in forming a radiant heat barrier in the form of droplets of fire-fighting fluid in at least a single plane, the sprinkler head including at least one radial arm pivotally connected at its centre to a hub about which the or each radial arm pivots, the or each arm including one or more generally tangential extensions, the or each extension disposed at an outer end of, and in fluid communication with a respective radial arm, so that fire-fighting fluid may be sprayed from the sprinkler head to form the radiant heat barrier in at least the radial plane.

Preferably a sprinkler head as described above wherein one or more generally tangential extensions extend at an angle both away from the radial direction and away from the tangential direction, so that fire-fighting fluid may be sprayed from the sprinkler head to form a radiant heat barrier in at least the radial plane and a second plane angled from both the radial plane and tangential planes.

Preferably a base is provided adjacent or integral with the hub so that the or each sprinkler head may be mounted on a wall which the radiant heat barrier is intended to protect. In preferred embodiments, in use, the radial arms rotate in a plane generally parallel to and spaced from the wall.

Preferably a first set of apertures are provided along the length of the or each radial arm to assist with rotation of the arm. Another set of apertures may be provided, to enable fire-fighting fluid to cool and/or treat the wall itself. In preferred embodiments the first set of apertures is disposed on the radial arm so as to discharge fluid tangentially from the apertures, and the second set of apertures is disposed along the radial arm so as to discharge fluid parallel to the or each radial arm's rotation axis.

The sprinkler head in preferred forms may be disposed on a wall of a building so as to provide a radiant-heat barrier, which utilises the winds associated with a fire front to force the fire-fighting fluid against the structure upon which the sprinkler head is mounted. In some embodiments, droplets are forced into eaves and roof cavities by the winds, to cool the places where embers may also be forced.

According to yet another aspect of the present invention there is provided a fire fighting apparatus suitable for use with a sprinkler or sprinkler system, the sprinkler and sprinkler system including a water supply under pressure, the water delivered to one or more selected locations via water delivery pipes having an outlet at the selected location and at least one sprinkler head in fluid communication with the outlet, the fire fighting apparatus including: a fire retardant supply and a proportioning means in fluid communication with the fire retardant supply and water delivery pipes, wherein the proportioning means delivers the fire retardant in a selected and controlled concentration to the water supply in the water delivery pipes.

Preferably the proportioning means is in fluid communication with the water delivery pipes at a connection upstream from the sprinkler head. In preferred forms the connection is in a range of 0.1 m to 500 m upstream from the sprinkler head. In one embodiment the connection is disposed 1 m upstream from the sprinkler head.

Preferably the fire suppressant is Acrylamide Copolymer Emulsion.

The concentration of the fire suppressant may vary within the range of 100:1 to 3000:1. In preferred embodiments the concentration metered by the proportioning means is 500:1.

Preferably the sprinkler head is of the kind used in internal automatic sprinkler systems, such as those found in multi-storey buildings. The sprinkler head for this aspect of the present invention may be in the form earlier described.

The or each sprinkler head may be utilised in forms of fire-fighting apparatus earlier described.

### DESCRIPTION OF PREFERRED EMBODIMENTS

In order to enable a clearer understanding of the invention, drawings illustrating preferred embodiments are attached, and in those drawings:

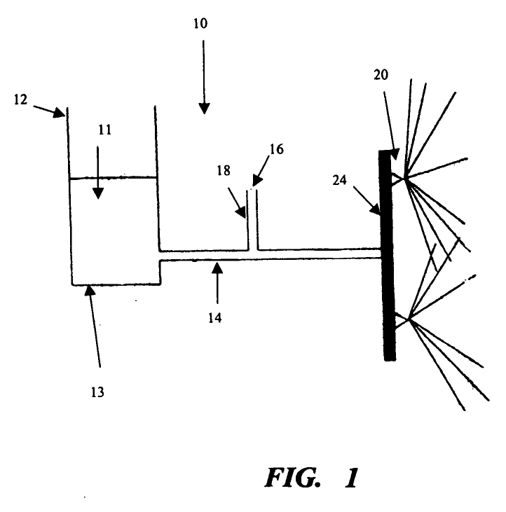

FIG. 1 is a schematic view of a preferred embodiment of a fire fighting apparatus showing water reservoir, water under pressure in delivery pipes, and the metered introduction of a fire suppressant into the pipes upstream of sprinkler heads;

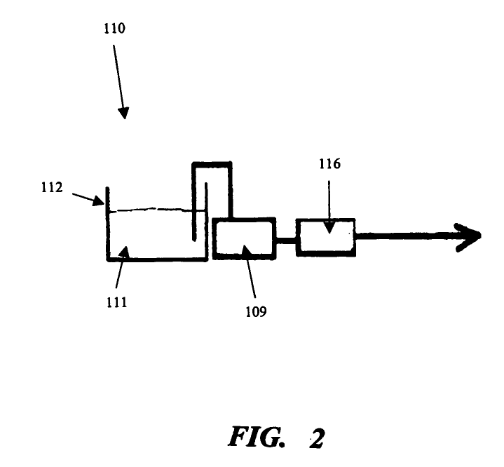

FIG. 2 is a schematic view of a similar embodiment to that shown in FIG. 1, being a water reservoir, pump and fire retardant metered into high-pressure water flow upstream from an outlet;

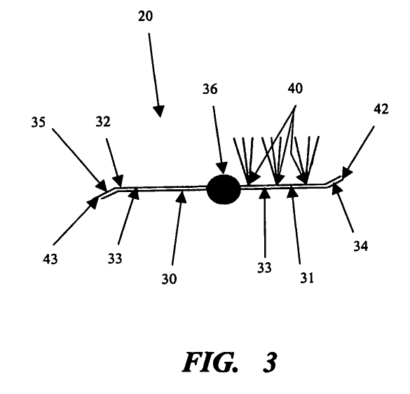

FIG. 3 is a plan schematic view of a sprinkler head according to a preferred embodiment of the present invention;

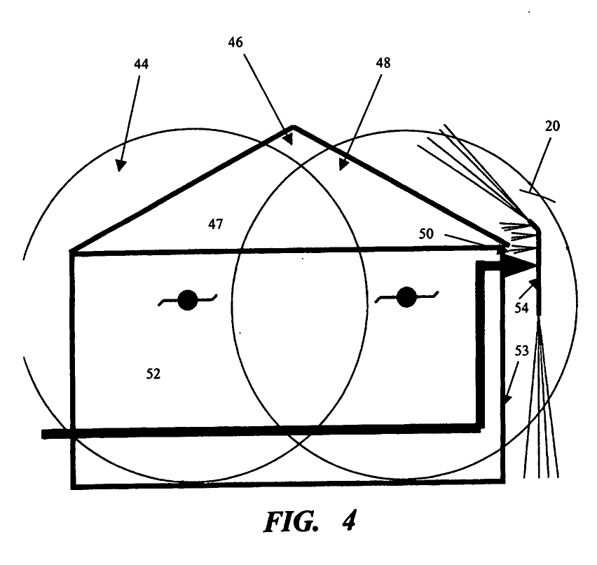

FIG. 4 is a front elevation view of a fire fighting apparatus according to one aspect of the present invention, showing three sprinkler heads as shown in FIG. 3, two sprinkler heads disposed on a front face of a building forming overlapping radiant heat barriers and a third sprinkler head on a side face of a building showing the manner in which fluid exits from the sprinkler arms;

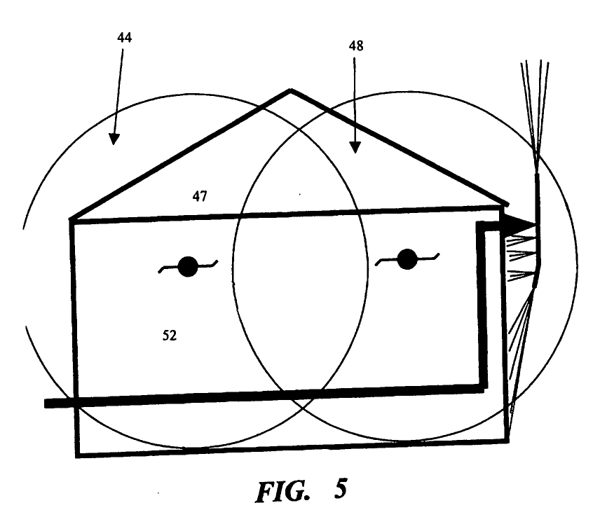

FIG. 5 is a similar view to that shown in FIG. 4, however, the side sprinkler head has rotated 180° to show the spray pattern in that orientation;

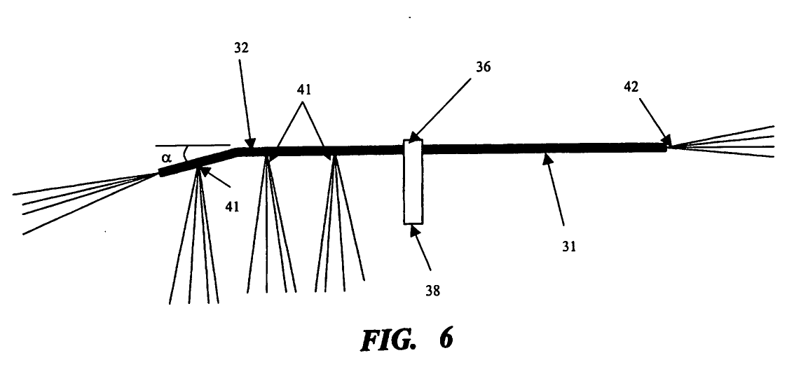

FIG. 6 is a side elevation schematic view of a sprinkler head shown in FIG. 3;

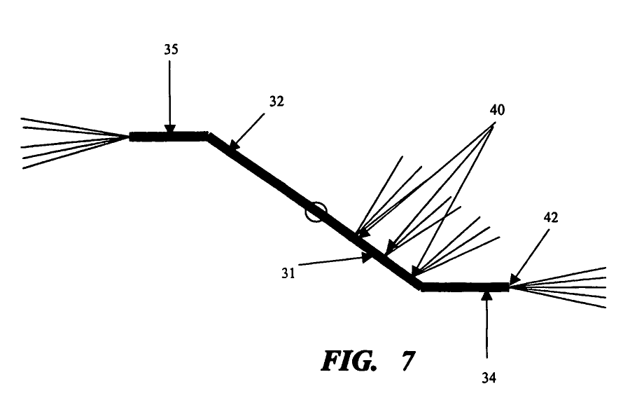

FIG. 7 is a plan schematic view of a sprinkler head shown in FIG. 3;

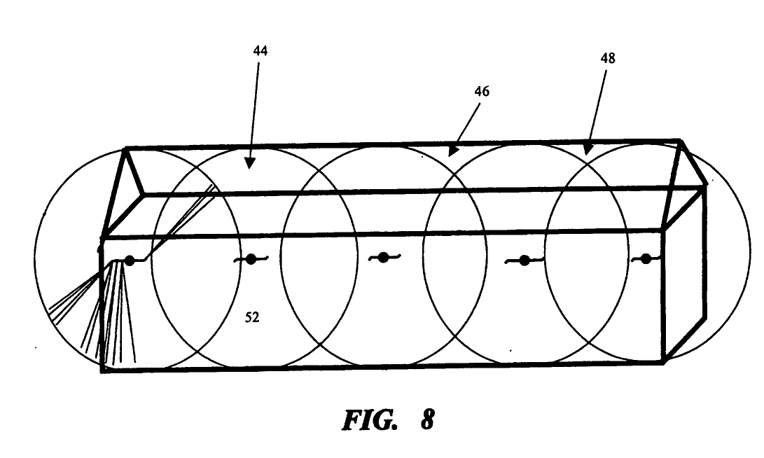

FIG. 8 is a perspective view of a fire fighting apparatus as shown in FIGS. 4 and 5, showing overlapping radiant heat barriers provided by a one-dimensional array of sprinkler heads;

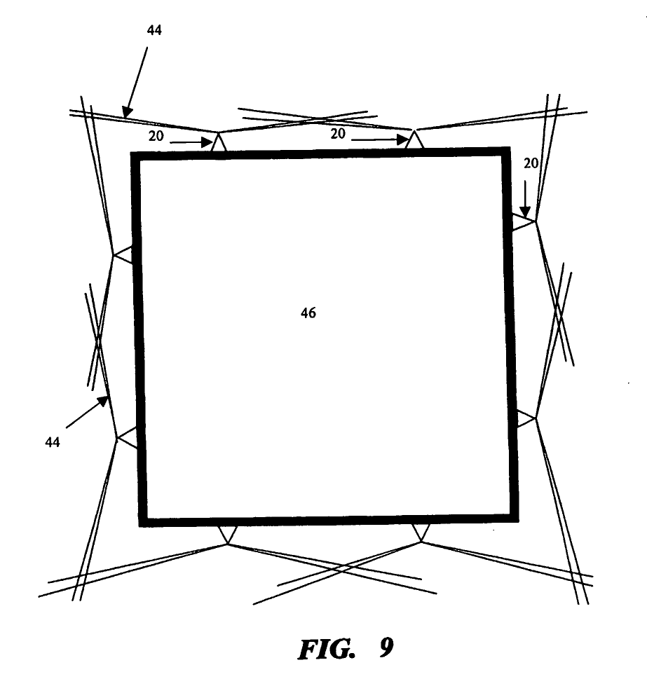

FIG. 9 is a plan schematic view of a fire fighting apparatus generally shown by the preferred embodiments in FIGS. 4 and 5, with the sprinkler heads offset from the wall an equal distance. The distance may in fact be varied between sprinkler heads in some embodiments if required.

Referring to FIG. 1 there is shown a preferred embodiment of fire fighting apparatus generally indicated at 10, including a water supply 11 contained within a reservoir 12 at the base 13 of which water delivery pipes 14 are in fluid communication.

A second embodiment of fire fighting apparatus is generally indicated at 110 in FIG. 2. Where more than one embodiment of an apparatus is shown as between FIGS. 1 and 2, like numerals denote like parts. Thus, in FIG. 2 a water supply is shown at 111 contained in a reservoir shown at 112. A pump 109 (not shown in FIG. 1) provides pressure in delivery pipes in fluid communication with sprinklers (20 in FIG. 1).

A proportioning device 16 is provided to deliver in controlled concentration an additive in the form of a fire suppressant being acrylamide copolymer emulsion, through fire suppressant delivery pipes 18. The pipes 18 add the suppressant to the water flow approximately 1 m upstream of manifold 24. The water/suppressant mixture travels through pipes and into the manifold 24 and sprinklers 20 before forming a radiant heat barrier 22.

Referring to FIGS. 3, 6 and 7 there is shown a sprinkler 20 including a sprinkler head 30, the head 30 including a first radial arm 31 and a second radial arm 32. The radial arms 31 and 32 are in the form of hollow tubes 33 which are pivotally connected to a pivot 36, the pivot 36 being integrally formed with a base/mount 38. Fluid may flow from the base 38 to the radial arms 31 and 32 by internal tubes (not shown).

Arm 31 includes a first tangential extension 34 which is formed in the tangential direction at an angle of approximately 45°. This arm 31 also includes side apertures 40 in side walls. Side apertures 40 are respectively in groups of three, in a single line spaced along the arm 31, each aperture approximately 1 mm in diameter. End apertures 42 are disposed in the end of the tangential extension 34.

Arm 32 includes a similar second tangential extension 35, which is generally disposed wholly within the plane in which the arms 31 and 32 rotate. The second tangential extension 35 is also formed at an additional angle α, approximately 15° away from the plane in which the radial arm rotates, towards the base 38. End apertures 43 are disposed in the arm 32 ends. A group of three rear apertures 41 are provided in arm 32, spaced along the arm. These are similarly arranged with side apertures 40, that is, in a single line along the rear wall, the diameter of each aperture being approximately 1 mm.

Apertures 40 and 41 are to ameliorate any shadow effect, that is to reduce the likelihood of any areas which not becoming wet or treated.

Referring additionally to FIGS. 4, 5, 8 and 9, each base 38 is mounted to a respective wall of a building 46, including front wall 52 and side wall 53, at a position slightly under the eaves of the building 46, or approximately 80% of the height of the walls 52 and 53. The sprinklers 20 are mounted so that the arms, when rotating, rotate in a plane parallel to the wall to which they are mounted. A radiant heat barrier 44 is formed in this embodiment by actuation of a line of sprinkler heads mounted along each wall. The barrier 44 is a plane of droplets parallel with and spaced from each wall by the distance of the mount 38. Each sprinkler 20 produces a plane circle of droplets of approximate radius 4 metres, and each circle overlaps that created by its adjacent sprinkler head 30, due to a spacing of heads 30 of approximately 6 metres.

In use the water/suppressant mixture is piped under pump pressure to the sprinkler head 30, and flows out from the ends through end apertures 42, 43, and other apertures 40 and 41. Water is forced out of the end apertures 42, 43 and side apertures 40 in an anticlockwise direction to enable clockwise rotation of the arms 31 and 32. Rear apertures 41 and end apertures 43 spray a surface or wall to which the base 38 is mounted and roof 48, to assist cooling of that surface and reduce heat damage and risk of combustion.

While a fire front approaches the building 46 a wind is created, forcing the droplets into spaces where embers also are forced by the wind, such as under eaves 50, into roof cavity 47 and onto roof 48, cooling those spaces and reducing the risk of combustion. The wind and the rear apertures 41 and end apertures 43 also force the droplets onto the walls upon which the sprinklers 20 are mounted, and also onto eaves 50 and into roof cavity 47.

Furthermore, the sprinkler heads 30 are charged with a water/suppression mixture, in a concentration that is known, so that the amounts of water used need not be so great as with a simple water charge. This is because the fire suppressant, active ingredient acrylamide copolymer emulsion, when in controlled concentrations, reduces the propensity for the water to be boiled off as steam. When used in controlled concentrations it thus keeps the water on a treated surface such as the building walls 52 and 53 and eaves 50 and roof 48, cooling the surfaces down and alleviating combustion. Furthermore, no foaming occurs at sprinkler leads.

Finally, it is to be understood that various alterations, modifications and/or additions may be incorporated into the various constructions and arrangements of parts without departing from the spirit or ambit of the invention.

1-35. (canceled)

36. A sprinkler head suitable for use in forming a radiant heat barrier in the form of droplets of fire-fighting fluid in at least a single plane, the sprinkler head including:
at least one hollow radial arm;
a hub operatively connected to the at least one hollow radial arm so that the at least one hollow radial arm may pivot about the hub so as to spin in a radial plane when in use;
an extension operatively connected to the or each hollow radial arm, the or each extension being disposed at an angle to the at least one radial arm, within the radial plane, and being disposed at an outer end of, and in fluid communication with the or each respective hollow radial arm; and
a nozzle to allow egress of fire-fighting fluid from the or each extension, and sprayed therefrom to form the radiant heat barrier in at least the radial plane.

37. A sprinkler head as defined in claim 36 wherein a base is provided for mounting the hub onto a structure, wherein one or more of the extensions extend at a second angle from the radial arm, towards the base, so that in use, fire-fighting fluid may be sprayed from the or each nozzle to drench distal parts of the structure.

38. A sprinkler head as defined in claim 36 wherein one or more apertures are provided along the or each radial arm to assist with rotation of the or each arm about the hub.

39. A sprinkler head as defined in claim 36 wherein one or more apertures are provided along the or each radial arm to enable fire-fighting fluid in use to drench proximal parts of a structure upon which the sprinkler head may be mounted.

40. A sprinkler head as defined in claim 38 wherein the or each aperture is disposed on the or each radial arm so as to discharge fluid tangentially from the or each aperture.

41. A sprinkler head as defined in claim 39 wherein the or each aperture is disposed so as to discharge fluid in a direction parallel to the rotation axis of the or each radial arm.

42. A sprinkler head as defined in claim 36 wherein two radial arms are provided, one radial arm having an extension angled from the radial arm, in the radial plane, and the other radial arm having an extension angled away from the radial plane.

43. A sprinkler head as defined in claim 36 wherein, in use, the sprinkler head is disposed on a wall of a building so as to provide a radiant-heat barrier which utilizes winds associated with a fire front to force the fire-fighting fluid against a structure upon which the sprinkler head is mounted.

44. A sprinkler head as defined in claim 36 wherein, in use, a spray barrier of fire-fighting fluid creates droplets which are forced into adjacent eaves and roof cavities by winds associated with fire, to drench the eaves and cavities into which embers may be forced by the winds.

45. A method of inhibiting fires, the method including the steps of:
providing one or more sprinklers according to claim 36;
positioning the or each sprinkler so as to be mounted in the region of a structure so that when fluid is forced under pressure through the or each sprinkler head, a radiant heat barrier of fluid droplets is formed to inhibit the radiant heat energy incident upon the structure.

46. The method according to claim 45 wherein a single-dimensional or two-dimensional array of sprinklers is provided adjacent to a building wall, in order to provide an overlap of the radiant heat barrier.
